(19) United States
(12) Patent Application Publication
(10) Pub. No.: US 2008/0130256 A1
(43) Pub. Date: Jun. 5, 2008

(54) PIN FORMATION OF ELECTRONIC COMPONENT

(75) Inventors: ZHEN-SHENG WANG, Shenzhen (CN); KE-YOU HU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) Co., LTD., Shenzhen City (CN); HON HAI PRECISION INDUSTRY CO., LTD., Tu-Cheng (TW)

(21) Appl. No.: 11/834,703

(22) Filed: Aug. 7, 2007

(30) Foreign Application Priority Data
Dec. 5, 2006 (CN) 200610201214.0

(51) Int. Cl. H01R 9/00

(52) U.S. Cl. 361/773

(57) ABSTRACT

A motherboard includes a printed circuit board having a first via and a second via, and an integrated circuit component having a first pin and a second pin. The integrated circuit component is mounted on the printed circuit board by inserting the first pin and the second pin of the integrated circuit component into the first via and the second via of the printed circuit board respectively, wherein the first pin and the second pin of the integrated circuit component are differently shaped in cross section, and the shapes of the first via and the second via are corresponding to the shapes of the first pin and the second pin. The electronic component cannot be mis-mounted on the PCB.

### BACKGROUND

1. Field of the Invention

The present invention relates to electronic components, and particularly to pin formation of an electronic component.

2. Description of Related Art

It is well known that electronic components, such as electrolytic capacitors, integrated circuit components, crystal resonators, etc., are widely used on motherboards.

Referring to FIG. 4, an LM78L05 integrated circuit component 10 includes a main body 12, an input pin 14, a ground pin 16, and an output pin 18, all of the pins extend down from a bottom 13 of the main body 12. The three pins 14, 16, and 18 are rectangular in cross section. The component 10 can be mounted on a printed circuit board (PCB) 15 by inserting the pins 14, 16, and 18 into corresponding rectangular vias 15a˜15c in the PCB 15 respectively.

Operators often mis-mount the integrated circuit component 10 on the PCB 15 by inserting the input pin 14 into the via 15c and the output pin 18 into the via 15a. The component 10 may be damaged when it is mis-mounted on the PCB 15, and the PCB 15 may be damaged too.

What is needed, therefore, is an electronic component which can solve the above problem.

### SUMMARY

An exemplary electronic component comprises a main body and at least two pins extending down from the main body, wherein the at least two pins are of different shape in cross section.

An exemplary motherboard comprising a printed circuit board (PCB) having a first via and a second via, and an integrated circuit (IC) component having a first pin and a second pin, the IC component mounted on the PCB by inserting the first pin and the second pin of the IC component into the first via and the second via of the PCB respectively, wherein the first pin and the second pin of the IC component are of different shape in cross section, and the first via and the second via are of complimentary shape to receive the first pin and the second pin respectively.

Other advantages and novel features will become more apparent from the following detailed description when taken in conjunction with the accompanying drawings, in which:

### BRIEF DESCRIPTION OF THE DRAWINGS

FIG. 1 is a schematic diagram of a first embodiment of an electronic component in accordance with the present invention and corresponding printed circuit board;

FIG. 2 is a schematic diagram of a second embodiment of an electronic component in accordance with the present invention and corresponding printed circuit board;

FIG. 3 is a schematic diagram of a third embodiment of an electronic component in accordance with the present invention and corresponding printed circuit board; and

FIG. 4 is a schematic diagram of a conventional electronic component and corresponding printed circuit board.

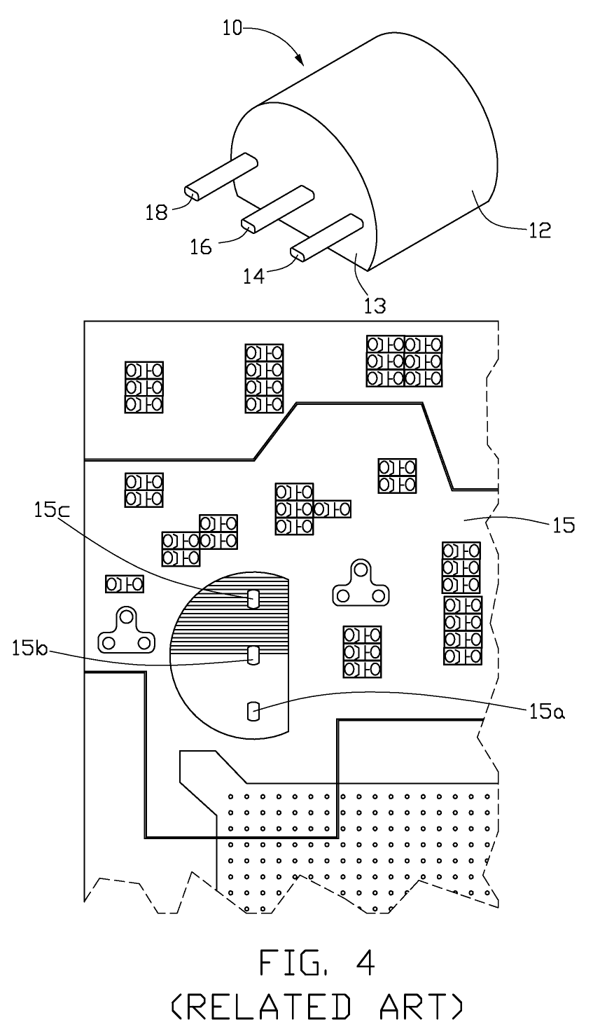

### DETAILED DESCRIPTION

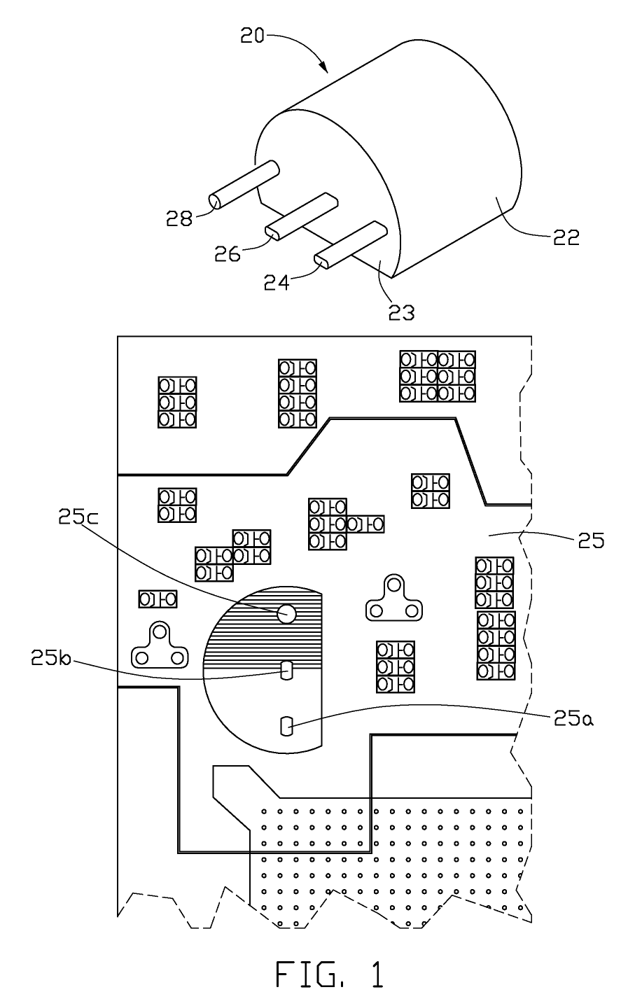

Referring to FIG. 1, an electronic component 20 in accordance with a first embodiment of the present invention includes a main body 22, a first pin 24, a second pin 26, and a third pin 28, wherein all of the pins 24, 26, and 28 extend down from a bottom 23 of the main body 22. The first pin 24 and the second pin 26 are rectangular in cross section. The third pin 28 is circular in cross section. The electronic component 20 can be mounted on a printed circuit board (PCB) 25 by inserting the pins 24, 26, and 28 into corresponding vias 25a˜25c in the PCB 25 respectively. The vias 25a and 25b are rectangular, and the via 25c is circular corresponding to the pins 24, 26, and 28. Therefore, the pin 28 of the electronic component 20 cannot be inserted into the via 25a of the PCB 25 thereby preventing the electronic component 20 from being mis-mounted on the PCB 25.

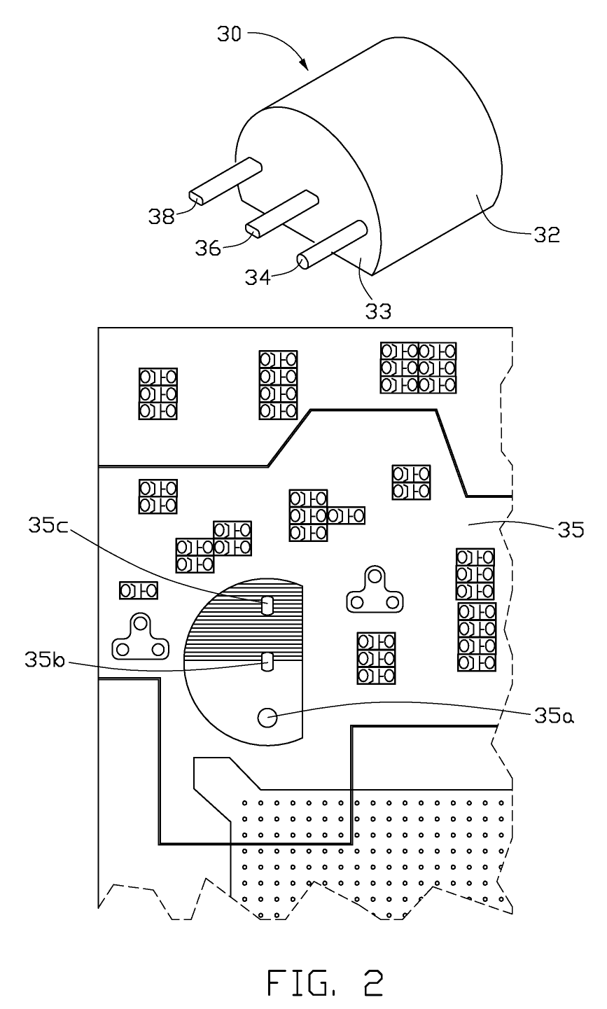

Referring to FIG. 2, an electronic component 30 in accordance with a second embodiment of the present invention includes a main body 32, a first pin 34, a second pin 36, and a third pin 38, wherein all of the pins 34, 36, and 38 extend down from a bottom 33 of the main body 32. The second pin 36 and the third pin 38 are rectangular in cross section. The first pin 34 is circular in cross section. The electronic component 30 can be mounted on a printed circuit board 35 by inserting the pins 34, 36, and 38 into corresponding vias 35a˜35c in the PCB 35 respectively. The vias 35b and 35c are rectangular, and the via 25a is circular corresponding to the pins 34, 36, and 38. Therefore, the first pin 34 of the electronic component 30 cannot be inserted into the via 35c of the PCB 35 thereby preventing the electronic component 20 from being mis-mounted on the PCB 35.

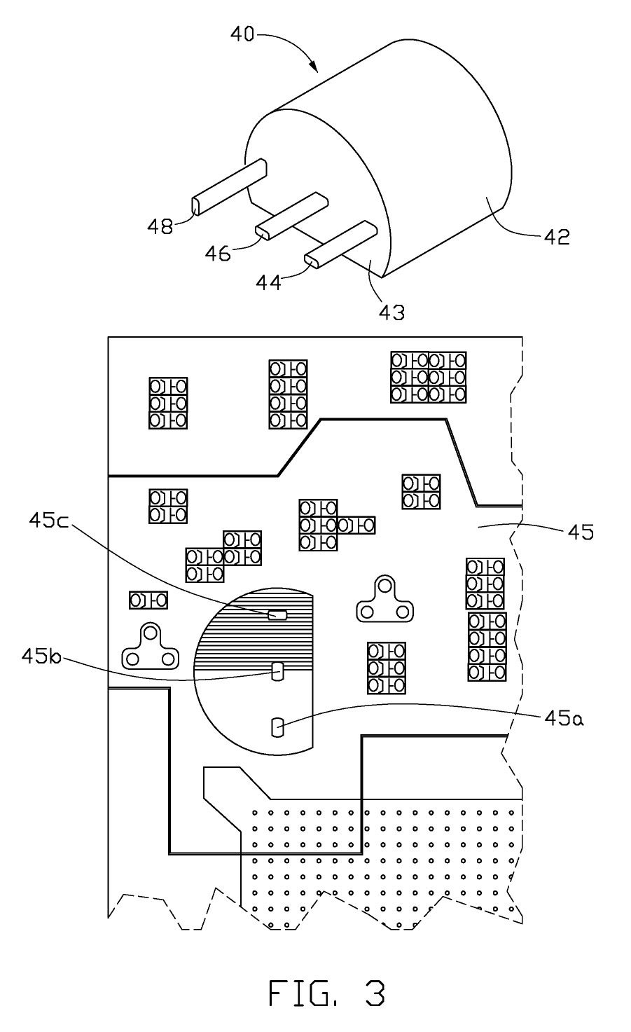

Referring to FIG. 3, an electronic component 40 in accordance with a third embodiment of the present invention includes a main body 42, a first pin 44, a second pin 46, and a third pin 48, each of the pins is extending down from the bottom 43 of the main body 42. The pins 44, 46, and 48 are rectangular in cross section and are arranged in a line. Pins 44 and 46 are oriented with their long sides parallel and pin 48 is oriented with its long sides perpendicular to the long sides of pins 44 and 46. The electronic component 40 can be mounted on a printed circuit board 45 by inserting the pins 44, 46, and 48 into corresponding vias 45a˜45c in the PCB 45 respectively. The vias 45a and 45b have a same shape and orientation as pins 44 and 46 and via 45c corresponds to pin 48. Therefore, the first pin 44 of the electronic component 40 cannot be inserted into the via 45c of the PCB 55, and the third pin 48 of the electronic component 40 cannot be inserted into the via 45a of the PCB 55 thereby preventing the electronic component 20 from being mis-mounted on the PCB 45.

Additionally, the shape of the pins and the vias as described above can also be triangular, elliptic, polygonal, etc, in cross section.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An integrated circuit component comprising a main body and at least two pins extending down from the main body, wherein the at least two pins are differently shaped in cross section.

2. The integrated circuit component as claimed in claim 1, wherein one of the at least two pins is rectangular in cross section, and another one of the at least two pins is circular in cross section.

3. The integrated circuit component as claimed in claim 1, wherein one of the at least two pins of is triangular in cross section, and another one of the at least two pins is circular in cross section.

4. A motherboard comprising:
a printed circuit board having a first via and a second via, and
an integrated circuit component having a first pin and a second pin, the integrated circuit component mounted on the printed circuit board by fittingly inserting the first pin and the second pin of the integrated circuit component into the first via and the second via of the printed circuit board respectively, wherein the first pin and the second pin of the integrated circuit component are differently shaped in cross section, and the shapes of the first via and the second via are corresponding to the shapes of the first pin and the second pin.

5. The motherboard as claimed in claim 4, wherein the first pin of the integrated circuit component and the first via of the printed circuit board are rectangular in cross section, and the second pin and the second via are circular in cross section.

6. The motherboard as claimed in claim 4, wherein the first pin of the integrated circuit component and the first via of the printed circuit board are circular in cross section, and the second pin and the second via are triangular in cross section.

7. The motherboard as claimed in claim 4, wherein each of the first and second pins of the integrated circuit component has a rectangular cross section which comprises a pair of long sides and a pair of short sides, the long sides of the first pin are perpendicular to the long sides of the second pin and the short sides of the first pin are perpendicular to the short sides of the second pin.
